(19) United States
(12) Patent Application Publication
(10) Pub. No.: US 2024/0010424 A1
(43) Pub. Date: Jan. 11, 2024

(54) Shuttle system for load handling in a warehouse

(71) Applicant: Cleveron AS, Viljandi (EE)

(72) Inventors: Remi Lõssov, Viljandi (EE); Tarmo Must, Viljandi (EE); Indrek Pettai, Intsu village (EE); Rein Saetalu, Ilbaku village (EE); Mart Leib, Viljandi (EE)

(21) Appl. No.: 18/218,376

(22) Filed: Jul. 5, 2023

Related U.S. Application Data
(60) Provisional application No. 63/358,971, filed on Jul. 7, 2022.
(60) Provisional application No. 63/493,151, filed on Mar. 30, 2023.

(51) Int. Cl. B65G 1/04

(52) U.S. Cl. CPC B65G 1/0435; B65G 1/0492; B65G 2207/08

(57) ABSTRACT

An unmanned warehouse shuttle with telescopic arms capable of handling various sizes of packages and moving them fast and stably on in a warehouse system. The system provides increased stability in that a solid platform with stationary side compartments is provided, and the telescopic arms are constructed in a way that the two extending parts move on top of each other rather than forming a layered structure. The width of the loading space and distance between the arms is adjustable with simple screw system. A unique extension system for the extendable arms is disclosed where two of the three parts of the arms are extending and provide an extension length that is more than twice the depth of the platform of the shuttle.

### PRIORITY

This application claims priority to U.S. provisional application No. 63/358,971 filed on Jul. 7, 2022, and of U.S. provisional application No. 63/493,151 filed on Mar. 30, 2023.

### FIELD OF INVENTION

This invention relates to load handling systems, especially in a warehouse setting, even more specifically to unmanned warehouse shuttle with telescopic arms.

### BACKGROUND OF THE INVENTION

There is a large number of disclosures for various kinds of load handling systems in a warehouse setting. A general feature of the systems includes a shuttle device moving between the warehouse shelves and reaching to pick packages, or items from the shelf to transport the package or items to a destination. A problem that many of the disclosures address is either how to load more than one package onto the shuttle at the very same time, or how to enable picking packages of different sizes onto the shuttle.

U.S. Pat. No. 8,790,061 discloses a transferring shuttle for use in a three-dimensional automated warehouse. The shuttle comprises sliding rails that comprise multiple finger elements such that the system can load more than one package at the time on the system in between the finger elements.

U.S. Pat. No. 10,894,663 discloses an automated storage retrieval system where telescopic arm assemblies include movable pusher elements and linearly moving tabs on the arms so as to change a distance between the tab and a finger to fit items of different size on the system. The telescopic arm is constructed to have multiple layers of extending and retracting members sliding in series within each other via belt and pulley arrangement in each of the telescoping members.

U.S. Pat. No. 10,865,042 as well as U.S. Pat. No. 9,522,781 disclose a device for gripping a load, wherein the system has chassis elements that are moving in relation to each other so as to change the width between gripping arms that are attached to the chassis portions and that way adopt to loading items of different widths. The system includes locking mechanisms to lock the chassis elements to preferred distance from each other. Drive assemblies including a rotatable drum and a cable extend and retracts the telescopic arms.

Thus, there are solutions providing various kind of tabs which may be stationary or moving on the arms to pick more than one package or packages with different depth onto the shuttle and there are systems where the shuttle comprises a loading space the width of which can be adjusted to pick packages with different width onto the shuttle.

Despite the multitude of existing solutions, there is a need for a shuttle system having a stable structure and where the telescopic arms can reach deep into the shelves and pick packages that are not only of different depth but also of different width. Moreover, there is a need for a shuttle system where the arms can extend deep into the shelf without a need to use multiple layers in extending elements.

### SUMMARY OF THE INVENTION

Accordingly, this disclosure provides solutions to a stable and reliable system capable of handling various sizes of packages and moving them fast and stably on the system. The system provides increased stability in that a solid platform with stationary side compartments is provided, and the telescopic arms are constructed in a way that the two extending parts move on top of each other rather than forming a layered structure. The width of the loading space and distance between the arms is adjustable with simple screw system. A unique extension system for the extendable arms is disclosed where two of the three parts of the arms are extending and providing an extension length that is more than twice the depth of the platform of the shuttle.

It is an object of this invention to provide an unmanned warehouse shuttle, configured to move along warehouse rails and retrieve and depose crates from and to the warehouse shelves, said shuttle comprising a platform having a width and a depth, and having at least four wheels underneath the platform configured to drive the shuttle along the warehouse rails; two stationary compartments on top of the platform on opposite edges of the platform in shuttle moving direction; two telescopic arms located in the inner side of the stationary compartments and leaving a loading space between the arms; the arms being configured to extend in synchrony to two directions perpendicular to the shuttle moving direction so as to reach toward the warehouse shelves; each telescopic arm comprising a first, a second, and a third part, each having a length equal to the depth of the platform, the first part being stationary, the second part being configured to extend almost half of its length over the platform's edge toward the warehouse shelves, and the third part being configured to move more than half of its length over a distal end of the second part, whereby each telescopic arm has an extension length that is more than twice the depth of the platform.

The telescopic arms of the shuttle are connected to each other with an attachment element, for example a screw from underneath of the platform such that a distance between the arms can be adjusted by turning the screw, thereby adjusting the width of the loading space in between the arms.

According to certain embodiments at each distal part of the third part there is a motor driven lever and optionally an optical sensor. According to certain embodiments the lever may be mechanical.

According to certain embodiments the shuttle has at least four rollers having a horizontal rotation axis attached on the platform above the wheels and the rollers are configured to roll along a vertical side of a warehouse rail and to hold a standard distance between the platform and the warehouse rail.

According to certain embodiments the extension of the telescopic arms of the shuttle is enabled by means of multiple pinions and toothed racks, wherein a motor driven pinion is attached in a middle of the first part and the pinion is assembled to be in contact with a toothed rack attached to the second part; a pinion assembly comprising two larger pinions and one smaller in between the larger ones is attached to the second part, the larger pinions are in contact with a rack of the third part, and the smaller pinion is in contact with a rack of the first part; while the pinions are configured to turn at same rate but due to their different sizes the rack of the third part moves more than the rack of the second part, and extension amount of the third part correlates to distance between axels and circumference of the smaller pinion and the larger one that is in contact with the rack of the third part.

According to certain embodiment the three pinions in the pinion assembly are in direct contact with each other, while according to another embodiment the three pinions in the pinion assembly are not in contact with each other, but each has its own pulley, and the pinions are connected with a toothed drive belt.

It is an object of the invention to provide a telescopic arm assembly for a warehouse shuttle, the assembly comprising two parallel telescopic arms assembled on a platform of the shuttle such that a loading space is between the arms; each arm comprising: a first part; a second part, and a third part each having an equal length; the first part being stationary, the second part being configured to extend almost half of its length over the platform's edge toward shelves of the warehouse, and the third part being configured to extend more than half of its length over a distal end of the second part, whereby each telescopic arm has an extension length that is more than twice the depth of the platform.

According to certain embodiments of the telescopic arm assembly, the extension of the telescopic arms is enabled by means of multiple pinions and toothed racks, wherein a motor driven pinion is attached in a middle of the first part and the pinion is assembled to be in contact with a toothed rack attached to the second part; a pinion assembly comprising two larger pinions and one smaller in between the larger pinions is attached to the second part, the two larger pinions are in contact with a rack of the third part, and the smaller pinion is in contact with a rack of the first part; while the pinions are configured to turn at same rate but due to their different sizes the rack of the third part moves more than the rack of the second part, and an extension amount of the third part correlates to distance between axels of the smaller pinion and the larger pinion that is in contact with the rack of the third part.

According to certain embodiments the three pinions in the pinion assembly are in contact with each other, while according to certain embodiment the three pinions in the pinion assembly are not in contact with each other, but each has its own pulley, and the pinions are connected with a toothed drive belt.

### BRIEF DESCRIPTION OF THE DRAWINGS

FIG. 1 illustrates the shuttle with a crate loaded on a loading space of the shuttle. The figure shows the shuttle having a platform (1) supporting two stationary side compartments (1a) and a loading space (1b) in between the side compartments and telescopic arms (4). The figure also shows wheels (2) having a horizontal rotation axis on the vertical ends (2b) of the side compartments as well as support rollers (3) having a vertical rotation axis attached on the platform underneath the wheels. The moving direction of the shuttle is illustrated with an arrow and in the terminology here below the width of the shuttle, or the width of the loading space or the width of the platform is measured in direction of the shuttle movement, while the term depth of the shuttle or the loading space or the platform is measured in direction perpendicular to the shuttle movement direction of the shuttle.

FIG. 2 is another view of the shuttle with a crate loaded on it. The side covers of the stationary side compartments have been removed in this illustration to allow a view to inside the compartment. The stationary side compartment houses at least one wheel drive motor (7)—in this figure two-wheel drive motors are illustrated- and an arm drive motor (5). Also, the telescopic arms (4) are shown.

FIG. 3. is a bottom view of the shuttle. In this figure two shafts (8) with bearings (10) are shown running in the direction of the width of platform and connecting the stationary side compartments. The telescopic arms (4) can be seen from below here. The telescopic arms (4) are connected together from below with at least one ball screw or trapezoidal screw illustrated with element number (9) here.

FIG. 4 shows the shuttle with an empty loading space and stationary side compartments without the side covers. Here a drive motor (6) is illustrated. This drive motor is connected to an end of the screw (9) shown in FIG. 3. In this figure also supercapacitors (42) are shown. The figure also shows rotating levers (11) at both ends of the third part (14) of the telescopic arm. Guiderails (12) at the loading space to guide the crate can be seen in this figure as well.

FIG. 5. shows the telescopic arm viewed from the stationary compartment side of the arm. The arm is here in fully retracted position. The figure shows the first part (13), a second part (15), and a third part (14) of the telescopic arm. The figure also shows a guiderail (12) at the loading space, the energy chain (16), the second part's rack (17), the third part's rack (18) and the first part's rack (26). The energy chain (16) is mounted from its first end to one distal end of the first part (13) and the other end is mounted to corresponding distal end of the third part (14). Furthermore, the bearings (10) (attached to the shafts (8)) are shown from the outside. The arm drive motor (5) is shown.

FIG. 6. shows from the telescopic arm in partially extended position when viewed from the stationary compartments side of the arm. The figure shows the first part (13), the second part (15), and the third part (14) of the telescopic arm. The second part's rack (17) and the third part's rack (18) are visible in the figure. Guiderails (22) are visible here, as well as the rollers (21). The first part (13) has also vertically adjustable rollers, the location of one of them is shown as element number (23).

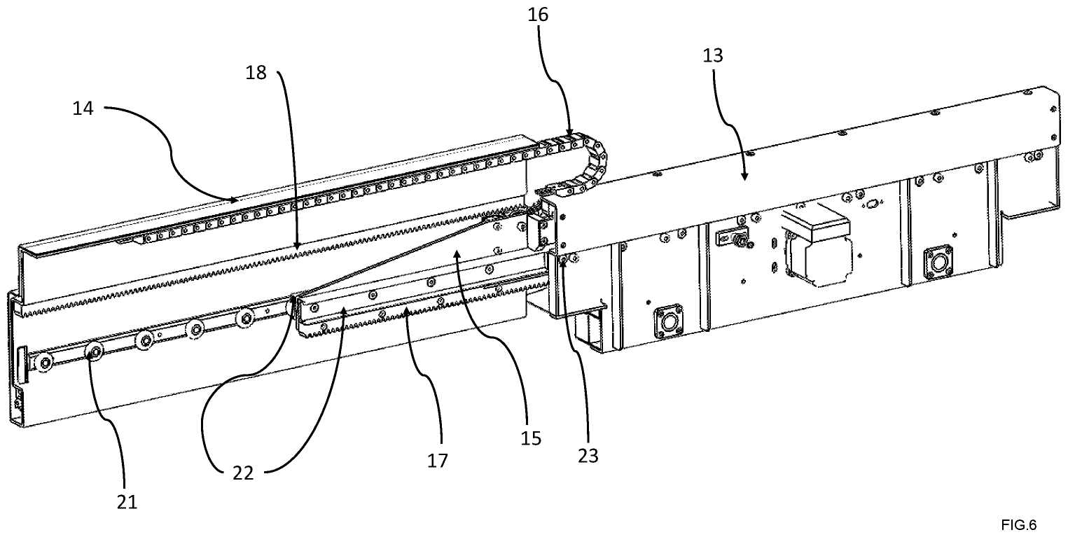

FIG. 7. shows the telescopic arm from the loading space side of the arm in partially extended position. The figure shows the first part (13), the second part (15), and the third part (14) of the telescopic arm. Second part's rack (17), the guiderail (22), and the rollers (21) are visible here as well. A motor driven pinion (25) in the inner side at about middle of the first part (13) of the arm can be seen in this figure. The pinion (25) is in contact with the second part's rack (17). Pinion complex (37) is also shown in this figure. First part's rack (26) and third part's rack (18) are in contact with the pinion complex.

FIG. 8 shows a detail of the pinions and toothed rack of the telescopic arm. The figure shows the pinion complex (37) comprising two larger pinions (34) and one smaller pinion (35). In this embodiment, the pinions are in direct contact with each other. First part's rack (26) and third part's rack (18) are in contact with the pinion complex.

FIG. 9 shows an even closer view of the pinion complex (37) and toothed first part's rack (26) of the telescopic arm. The pinion complex (37) comprises two larger pinions (34) and one smaller pinion (35) in between the two larger ones. It is shown that the pinions are in direct contact with each other, and larger pinions (34) are in contact with the third part's rack (18). The smaller pinion (35) is connected with a supplemental pinion (36) having fewer teeth than the small pinion and being in contact with the first part's rack (26).

FIG. 10. shows an inside detail view of the third part with its inner cover removed and a close view of the rotating levers (11). The rotating levers (11) are attached to the ends of the third part (14) of the telescopic arm. Each lever is connected to a lever motor (40) that rotates the lever. In the figure the rotating lever is in closed position. Also, optical (41) sensors may be located at the distal ends of the third part.

FIG. 11. shows an alternative solution for the pinion complex and the rack system of the extendable arm. The figure shows the two large pinions (34) and one supplemental pinion (36). In this embodiment the pinions are not in direct contact with each other, but they are all connected with a toothed drive belt (20).

FIG. 12 shows closely how the wheels (2) and support rollers (3) are in contact with a structure of warehouse rail (24). The wheels run on top of the rail while the support rollers guide the shuttle along the inner surface of the rails.

FIG. 13 shows the platform (1), the first part (13), the second part (15) and the third part (14) of the telescopic arm. The telescopic arm is in extended position here. The platform's depth is p1 and the length of the extended third part (14) is also p1, however, the overall extension of the arm is p2 which is greater than p1 due to the additional extension provided by the second part (15). The rail structure of the warehouse is shown as element 24.

### DETAILED DESCRIPTION OF THE INVENTION

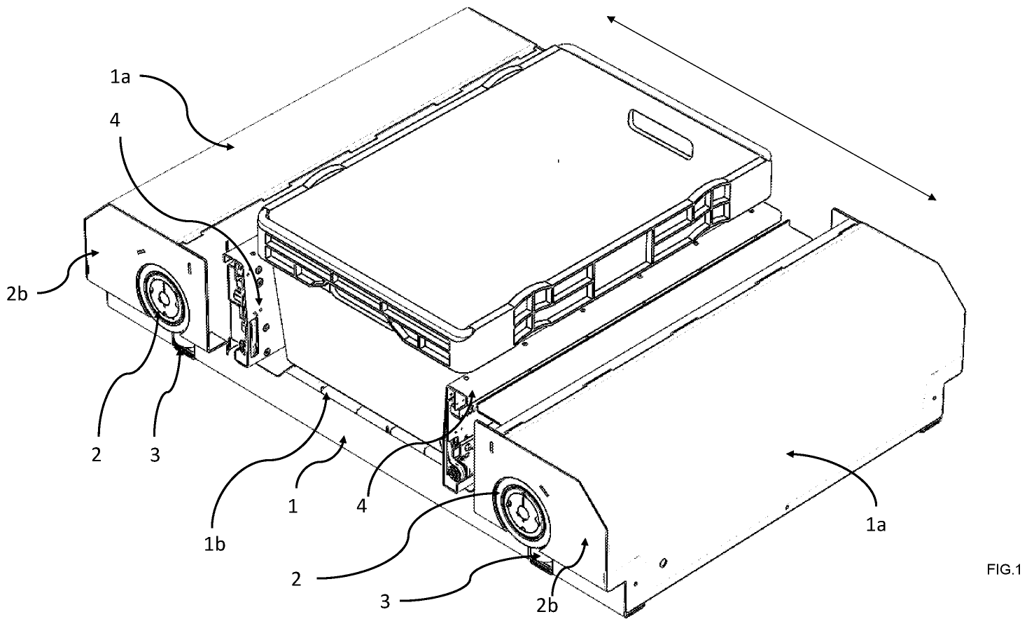

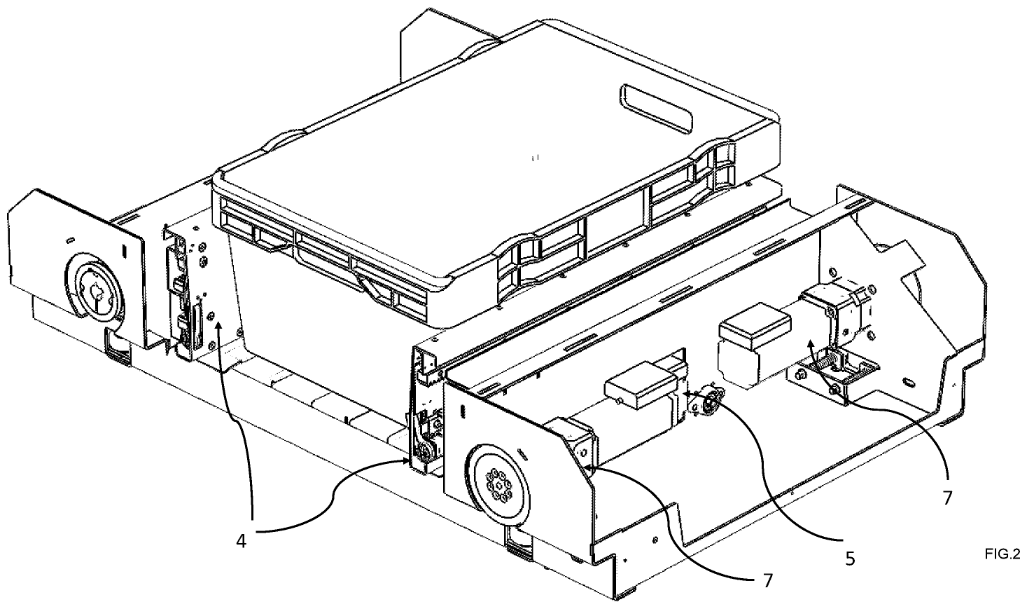

The shuttle of this disclosure comprises a platform (1), two stationary side compartments (1a), two telescopic arms (4) and a loading space (1b) in between of the side compartments to load a crate. The shuttle has an even number of wheels (2) such that half of the wheels are on one side and half of them on the other side of the platform. The wheels are preferably located on opposite sides of the side compartment. Preferably the shuttle has four wheels, two on each side as is shown in FIG. 1. At least one of the wheels is driven by a wheel drive motor (7). FIG. 2 shows two motors driving two wheels of the shuttle.

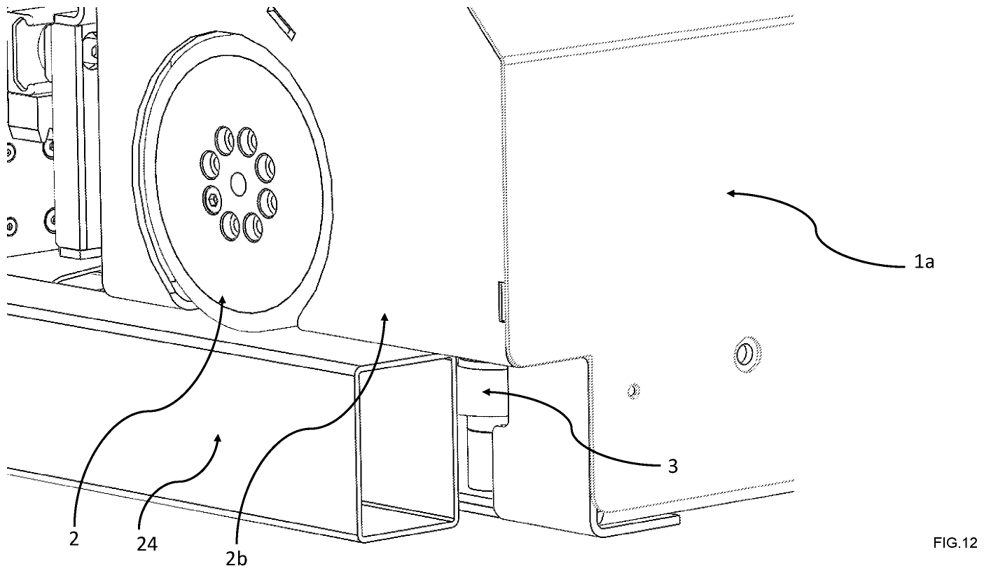

The wheels are configured to move the shuttle along an aisle of a warehouse structure between the shelving structures on warehouse rail structures (24). The rail structures are preferably created by the shelving's most forward part that protrudes into the corridor between the shelving structure. The wheels are preferably made of polyurethane or similar wear resistant material. FIG. 12 illustrates the wheels (2) on top of a warehouse rail structure (24).

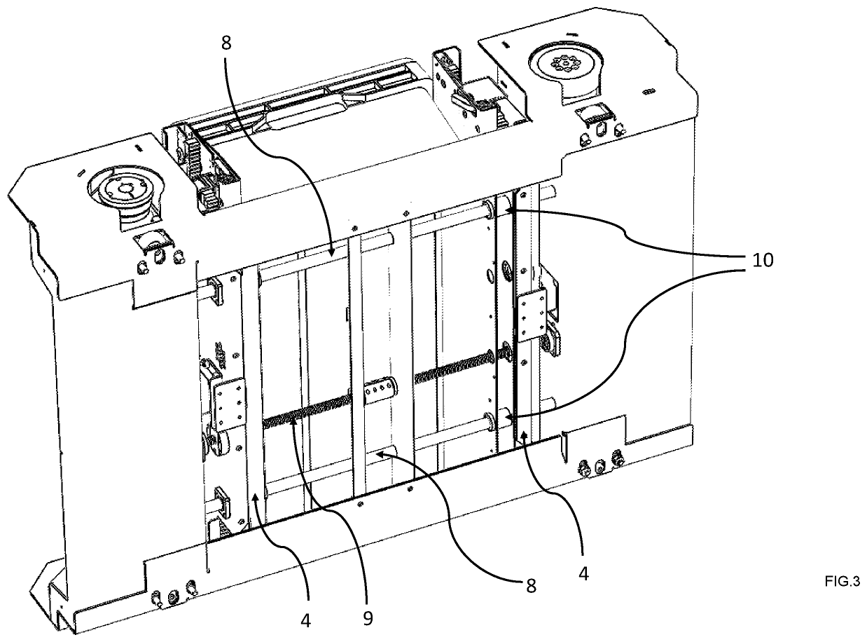

In addition to the wheels, the shuttle has an even number of support rollers (3) such that two sides of the platform have an equal number of support rollers. In FIG. 3, two support rollers are visible on one side of the platform. Two rollers, not visible in this figure, are on the other side of the platform. The support rollers are preferably located on the platform (1) underneath the wheels. These support rollers have rolling axles that are vertical and their purpose is to limit sideways movement of the shuttle while moving along the warehouse rail structure (24) along the aisle (see FIG. 12). The support rollers are also providing support during the loading and unloading of crates or items to and from the loading space of the shuttle. Furthermore, the support rollers keep the shuttle at a constant distance from the rail (24) and smooth out any deviation in the distance between the rails. These support rollers (3) are in contact with the same rail structure as the wheels (2), however, the support rollers contact the side of the warehouse rail structure (24) while the wheels contact the top of the warehouse rail structure.

In one embodiment, the shuttle has at least one wheel drive motor (7) within one side compartment that is connected to a common axle connecting two wheels via a drive belt. In an alternative preferred embodiment, the shuttle has two-wheel drive motors (7) connected directly to the wheels via a gearbox and the wheels move in synchrony with each other (shown in FIG. 2).

The shuttle is equipped with two telescopic arms (4). These arms (4) are located on the platform (1) such that a loading area (1b) is in between the arms and the stationary side compartments (1a) are located on outer sides of the arms on the outer edges of the platform. The arms are configured to extend in the perpendicular direction to the moving direction of the shuttle. Telescopic arms (4) move in synchrony with each other, and they can extend to both directions perpendicularly against the moving direction of the shuttle. Both arms have their own arm drive motor (5). The arm drive motors are connected to the first parts of the arms and protrude the walls of the side compartments.

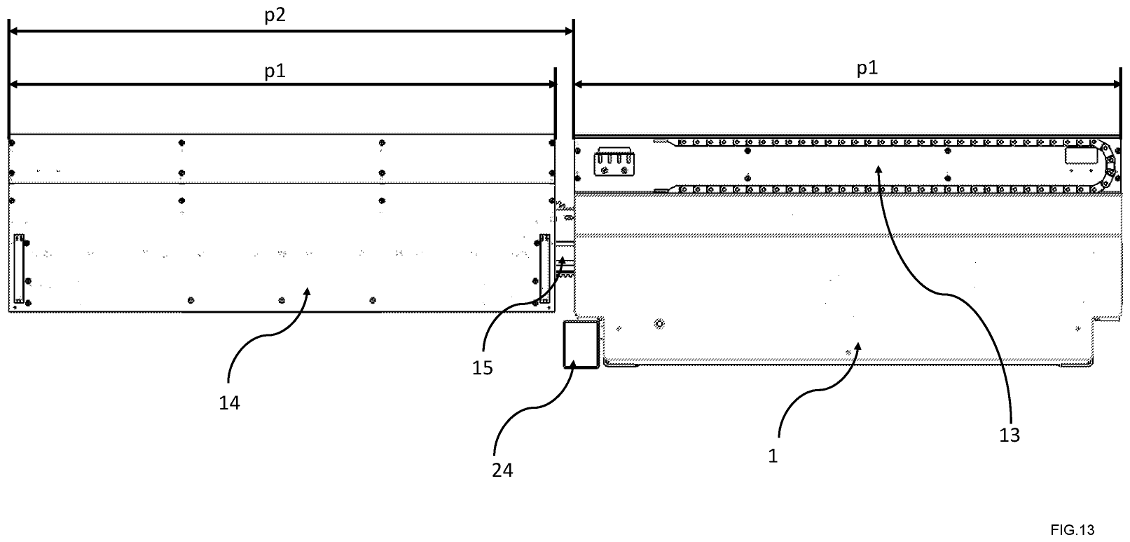

The telescopic arms of this disclosure are configured to extend in two directions such that the extension length of the arms in either direction is more than twice the depth of the platform. In retracted position the arms have a length equaling to the depth of the platform, but in fully extended position the length of the arm is more than the depth of the platform as shown in FIG. 13. This is a unique solution provided by this invention. This feature provides a system that can reach crates or packages stored deep in a shelving system, as well as large packages. To achieve this overextension, the telescopic arms (4) comprise three parts:

The first part of the telescopic arm (13) does not move in relation to the platform, the second part (15) moves almost half of its length over the platform's edge and the third part (14) moves more than half of its length over the distal end of the second part so that the distal end of the third part is further away from the platform than the entire length of the third part. The length of each of the first, second and third part of the arm is preferably the same as the depth of the platform. In order to provide such telescopic arm capable of such overextension, the system requires specific features enabling the extension in a stable manner. The structure and function of the telescopic arms is described below in more detail.

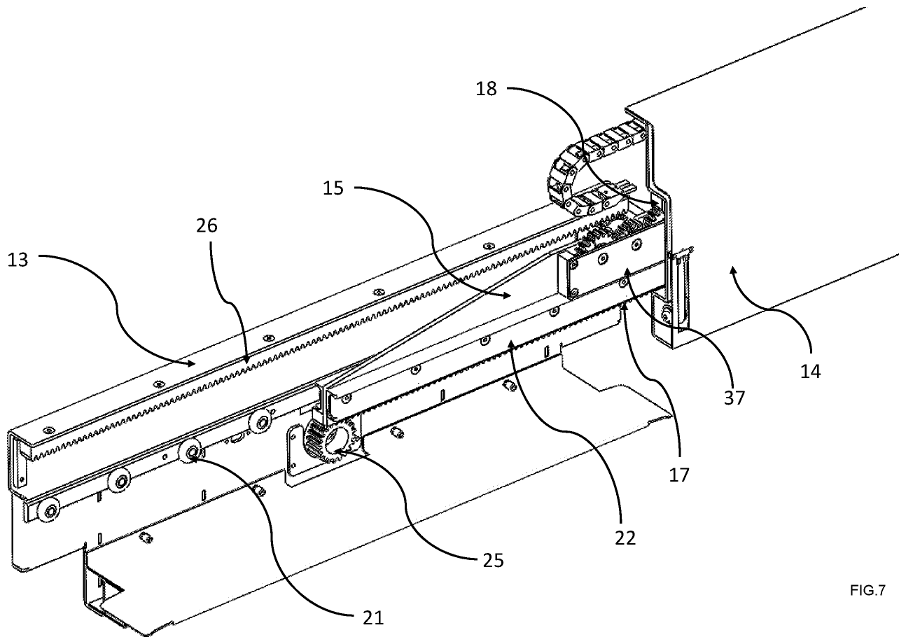

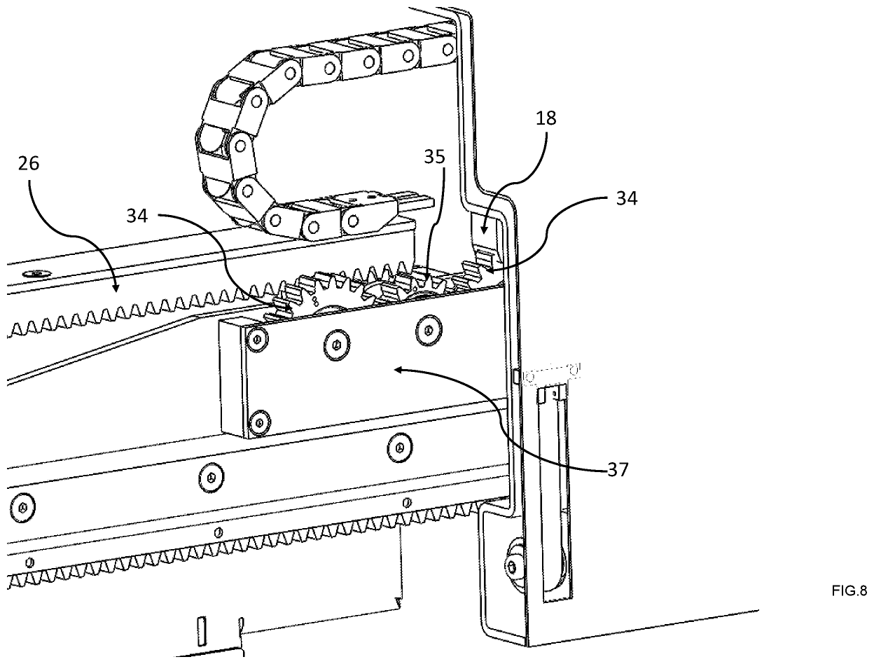

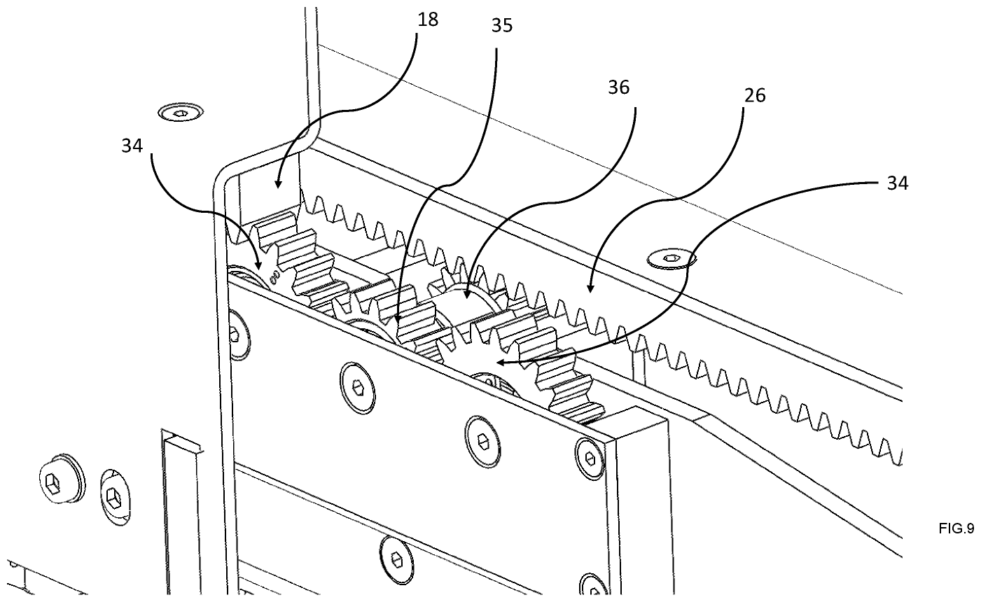

In a preferred embodiment the second (15) and the third part (14) extend towards the shelves and crates that are located on the shelves. In the middle of the first part (13) there is an arm drive motor (5) driven pinion (25) in contact with a toothed rack (17) that is attached to the second part (15) (second part's toothed rack). The pinion's rotation causes the second part to extend almost as far as half the length of the second part (15) while still staying in contact with the rack (17). (See FIG. 7). The second part (15) has three pinions preferably in a pinion complex (37). Two pinions (34) are larger than the third (35) (see FIG. 8). The pinions are arranged in such a way that the larger pinions (34) are in contact with a toothed rack (18) located on the third part (14) (third part's toothed rack) and the smaller pinion (35) is not directly contacting a toothed rack (26) located on the first part (13) (first part's toothed rack) but is connected rigidly to a supplemental pinion (36) that is in contact with the first part's rack (26)(see FIG. 9). The larger pinions (34) are in contact with the smaller pinion (35), smaller pinion's (35) rotation causes the third part (14) to move. The smaller pinion (35) has not the same amount of teeth as the supplemental pinion (36) that is in contact with the first part's rack (26), although they share one axis and are connected rigidly to each other so that they rotate the same amount but cause different movement length of the rack's they contact. The smaller pinion (35) has more teeth than the supplemental pinion (36) and this difference causes the third part (14) to move more than the second part (15) because smaller pinion 35 is in contact with the third part's rack (18) and the supplemental pinion is in contact with the first part's rack (26). In a preferred embodiment the toothed racks (18 and 26) are reversed meaning the teeth are on the bottom side of the rack and the rack is located higher in the assembly and the pinions are arranged in such a way that they are in contact with the racks from underneath.

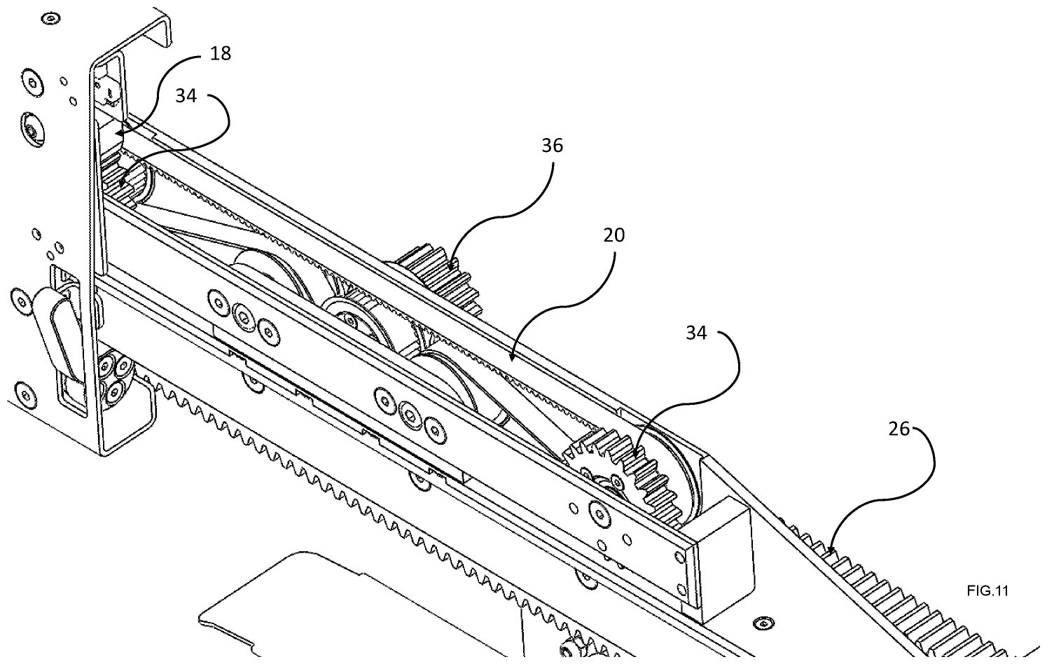

FIG. 11 shows an alternative solution for assembly of the pinions in the telescopic arm. As the overextension amount of the third part is determined by the distance between the axles of the pinions in the pinion complex (37), this embodiment is designed to provide longer distance between the axles and thus allowing greater overextension. Similarly, as in the above-described solution the second (15) and third part (14) extend towards the shelves and crates that are located on the shelves. Here too, in the middle of the first part (13) there is an arm drive motor (5) driven pinion (25) in contact with a toothed rack (17) that is attached to the second part (15) (second part's toothed rack). Similarly, as is described above, rotation of the three pinions causes the second part to extend almost as far as half the length of the second part (15) while still staying in contact with the toothed rack (17). In this embodiment as shown in FIG. 11 the second part (15) has three pinions: two large pinions (34) and a supplemental pinion (36). The two pinions (34) are larger than the supplemental third (36). The pinions are arranged in such a way that the larger pinions (34) are in contact with a toothed rack (18) of the third part (14) and the smaller pinion (36) is contacting a toothed rack (26) of the first part (13). In this embodiment the pinions are not in contact with each other, but they are all connected with a toothed drive belt (20). All the pinions have separate toothed pulleys attached to them. These pulleys are all of the same size, and the toothed drive belt (20) connects all of them into a single drive system. This causes all the pinions to turn at the same rate but because the smaller supplemental pinon (36) is contacting the first part's rack (26) and the larger pinions (34) are contacting the third part's rack (18), the third part (14) moves more than the second part (15). In this alternative embodiment the distance between the axles of pinions (36) and (34) can be much longer than in the first embodiment shown FIG. 7 and described in previous paragraph. This solution allows the third part to overextend as much as needed by providing assemblies with a longer distance between the pinons.

Rollers (21) for the telescopic arm parts are located on the first (13) and the third part (14). (See FIG. 7). Both parts have a multitude of rollers (21) that are positioned on one plane and their axles are in line with the shuttle's moving direction. The second part (15) houses two guide rails (22) for their corresponding first- and third-part rollers that displace in and out of their rail in the extending direction of the arm. On the first part (13) and the third part (14) some of the rollers can be adjusted in the vertical dimension (23) to remove slack from the rack and pinion contacts and guide rail and roller contacts.

The telescopic arms (4) can also move in the direction of the moving direction of the shuttle. This movement changes the distance between the arms (4). To achieve this movement both arms (4) are connected with at least one ball screw or trapezoidal screw (9) mechanism (FIG. 3).

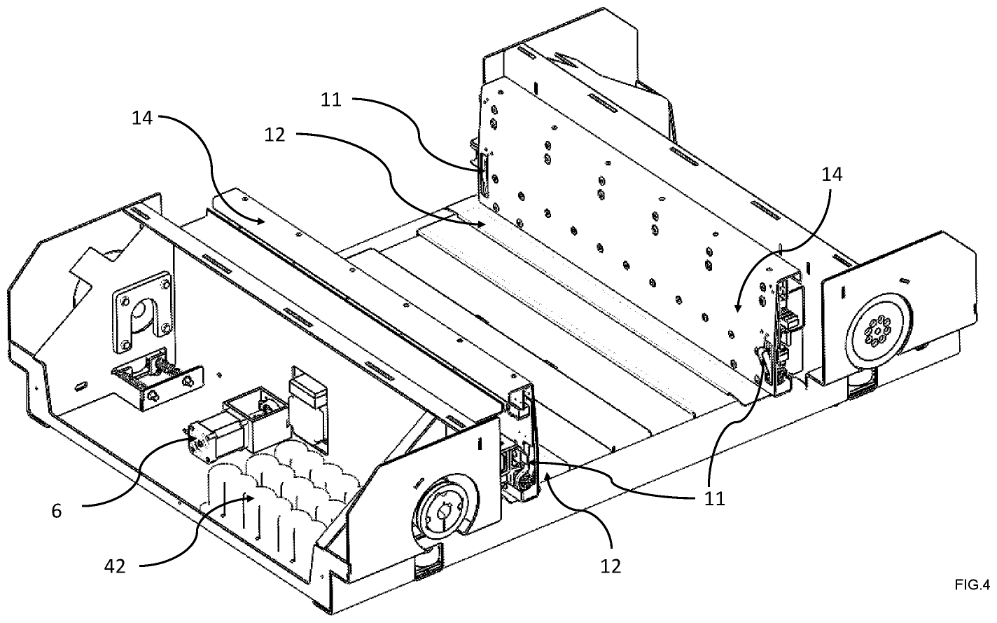

Each arm has two linear bearings (10) that are mounted on shafts (8) connecting two halves of the platform i.e., the shafts extend between the two stationary side compartments and through a bottom portion of the first parts (13) of each arm. Each arm also has one screw nut that is mounted on a screw (9) that is supported on both ends of the platform. On one end of the screw there is a drive motor (6) that turns the screw (9). (See FIGS. 3 and 4). The screw (9) has a thread that changes its direction in the middle of the screw or there are left, and right-handed screws mounted together in the middle with a coupling. This means that when the screw (9) is turned the arms move in synchrony in opposite directions i.e., the arms move closer to each other or further away from each other thereby providing means to adjust the width of the loading space in between of the arms. This sideways movement of the arms also allows the telescopic arm to reach to larger or smaller items on the shelf. In case of multitude screw assemblies, the screw ends are connected with a drive belt. In another embodiment the arm assemblies are mounted not on a linear bearing but directly on a screw nut and the linear rails are replaced with ball screws which also act as linear rails. Both arms (4) have guide rails (12) attached to the first part. These guide rails (12) support the crate while it is on the platform and provide reduction in sliding resistance while the crate is moved onto or off the platform.

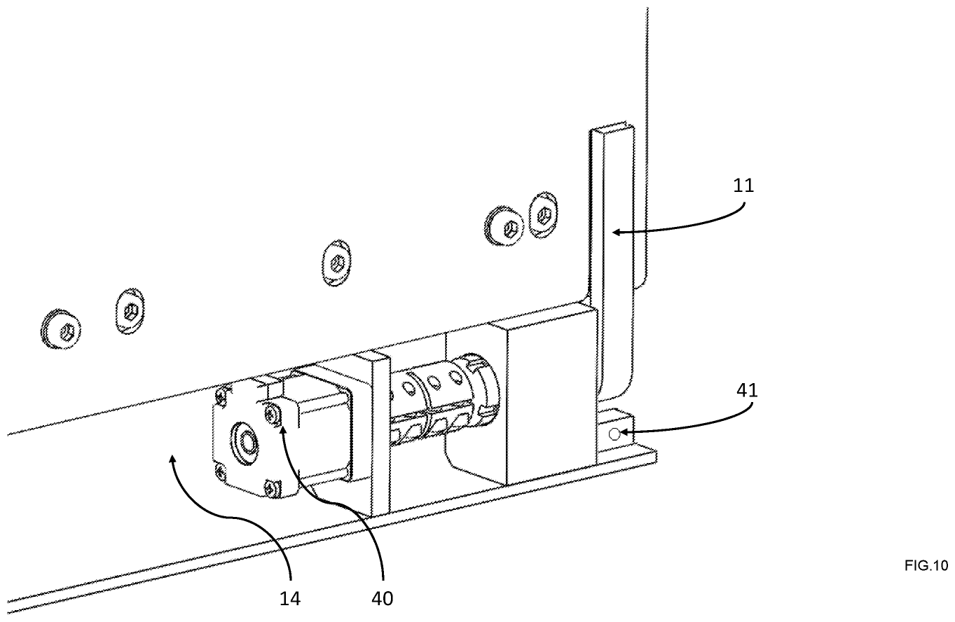

At the distal ends of the third parts (15) of the arms there are rotating levers (11). (See FIG. 10.) These levers (11) rotate around their axis that is parallel to the arm's extension direction and they can rotate independently from each other. The rotation is achieved by a lever motor (40) located inside the third part (15). Alternatively, the levers may be operated mechanically. The levers (11) can be rotated to a vertical position so that they do not protrude the inside surface of the third part. In some embodiments optical sensors (41) are also located at both distal ends of the third part. Each end has at least one optical sensor component, either a sender or receiver that is paired with the other arm's sender or receiver forming pairs.

The levers (11) are in their vertical position while the telescopic arm is being extended to grab a crate. In one embodiment, while extending past the crate located on the shelf the optical sensor's line of vision is blocked by the crate. When the arms extend past the crate the optical sensors in each arm will see each other or in another embodiment the position of the arm part is confirmed by motor's encoder and the extending motion will stop, and the levers will rotate behind the crate. The arms (4) will move some distance closer to each other (via the turning of the screw (9) as described above) to minimize the crates movement from side to side during crate's moving and then the telescopic arms are retracted to pull the crate onto the platform.

To move the crate back to the shelf on the opposite side, the levers (11) are already at the back of the crate, or they are rotated to the back of the crate. The arms (4) are extended towards the shelves and the crate is pushed back with them. To move the crate/tote/parcel to the same side of the shelves the levers (11) on the other end of the arms are rotated behind the crate and the crate is pushed onto the shelf with them. The levers (11) are rotated to their vertical position and the arms are retracted back to the platform leaving the crate behind.

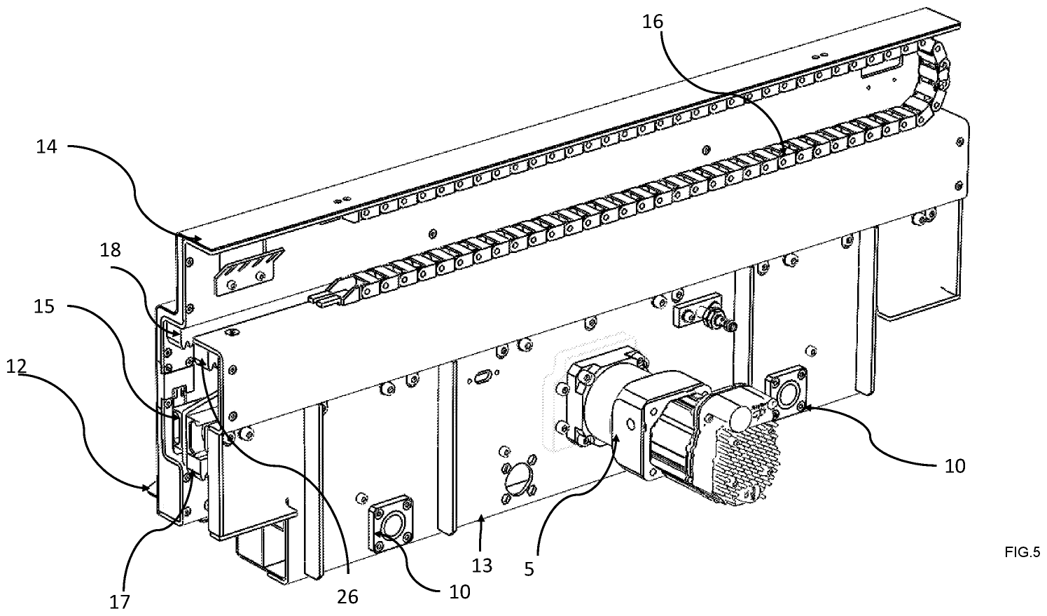

Power and signal cables are positioned on top of the telescopic arms first part (13) and underneath the third part's (14) upper section. One end of the energy chain (16) is mounted to one distal end of the first part (13) and the other end is mounted to the corresponding distal end of the third part (14) as is shown in FIG. 5.

At one end of the platform there are supercapacitors.

### LIST OF ELEMENT NUMBERS

1 Platform
1a Stationary side compartments
1b Loading space in between the side compartments
2 Wheel(s)
2b Vertical ends of side compartment
3 Support roller(s)
4 Telescopic arm(s)
5 Arm drive motor
6 Drive motor
7 Wheel drive motor
8 Shaft
9 Screw
10 Bearing(s)
11 Rotating lever(s)
12 Guiderail at loading space
13 First part of telescopic arm
14 Third part of telescopic arm
15 Second part of telescopic arm
16 Energy chain
17 Toothed second part's rack
18 Toothed third part's rack
20 Toothed drive belt
21 Roller(s)
22 Guiderail(s)
23 Vertically adjustable roller
24 Rail structure of the warehouse
25 Motor driven pinion in about middle of the inner side of the first part
26 Toothed first part's rack
34 Large pinion(s) in pinion complex
35 Small pinion in the pinion complex
36 Supplemental pinion
37 Pinion complex
40 Lever motor
41 Optical sensor
42 Supercapacitor

What is claimed is:

1. An unmanned warehouse shuttle, configured to move along warehouse rail structures and retrieve and depose crates from and to warehouse shelves, said unmanned warehouse shuttle comprising:
a platform having a width and a depth, and having at least four wheels underneath the platform configured to drive the unmanned warehouse shuttle along the warehouse rail structures;
two stationary compartments on top of the platform on opposite edges of the platform in moving direction of the unmanned warehouse shuttle;
two telescopic arms located in inner sides of the two stationary compartments and leaving a loading space between the arms;
the telescopic arms being configured to extend in synchrony to two directions perpendicular to the moving direction of the unmanned warehouse shuttle so as to reach toward the warehouse shelves;
each telescopic arm comprising a first, a second, and a third part, each having a length equal to the depth of the platform, and
the first part being stationary, the second part being configured to extend almost half of its length over an edge of the platform toward the warehouse shelves, and the third part being configured to move more than half of its length over a distal end of the second part, whereby each telescopic arm has an extension length that is more than twice the depth of the platform.

2. The unmanned warehouse shuttle of claim 1, wherein
the telescopic arms are connected to each other with an attachment element from underneath of the platform such that a distance between the telescopic arms can be adjusted by moving the attachment element, thereby adjusting the width of the loading space in between the telescopic arms.

3. The unmanned warehouse shuttle of claim 1, wherein in each distal part of the third part there is a lever and optionally an optical sensor.

4. The unmanned warehouse shuttle of claim 3, wherein the lever is motor driven or mechanical.

5. The unmanned warehouse shuttle of claim 1, wherein the unmanned warehouse shuttle has at least four rollers having a horizontal rotation axis attached on the platform below the at least four wheels and wherein the at least four rollers are configured to roll along a vertical side of a warehouse rail structure and to hold a standard distance between the platform and the warehouse rail structures.

6. The unmanned warehouse shuttle of claim 1, wherein extension of the telescopic arms is enabled by means of multiple pinions and toothed racks, wherein
a motor driven pinion is attached in a middle of the first part and the motor driving pinion is assembled to be in contact with a toothed rack attached to the second part;
a pinion complex comprising two large pinions and one small pinion in between the large pinions is attached to the second part, the large pinions are in contact with a rack of the third part, and the small pinion is in contact with a rack of the first part; and
while the pinions of the pinion complex are configured to turn at same rate but due to their different sizes the rack of the third part moves more than the rack of the second part, and extension amount of the third part correlates to distance between axels and circumference of the small pinion and the large one that is in contact with the rack of the third part.

7. The unmanned warehouse shuttle of claim 6, wherein the pinions in the pinion complex are in direct contact with each other.

8. The unmanned warehouse shuttle of claim 7, wherein the pinions in the pinion complex are not in contact with each other, but each has its own pulley and the pinions are connected with a toothed drive belt.

9. A telescopic arm assembly for an unmanned warehouse shuttle, the assembly comprising two parallel telescopic arms assembled on a platform of the unmanned warehouse shuttle such that a loading space is between the telescopic arms; each telescopic arm comprising:
a first part; a second part and a third part each having an equal length; and
the first part being stationary, the second part being configured to extend almost half of its length over an edge of the platform toward shelves of the warehouse, and the third part being configured to extend more than half of its length over a distal end of the second part, whereby each telescopic arm has an extension length that is more than twice of a depth of the platform.

10. The telescopic arm assembly of claim 9, wherein the extension of the telescopic arms is enabled by means of multiple pinions and toothed racks, wherein
a motor driven pinion is attached in a middle of the first part and the pinion is assembled to be in contact with a toothed rack attached to the second part;
a pinion complex comprising two large pinions and one small pinion in between the large ones is attached to the second part, the large pinions are in contact with a rack of the third part, and the small pinion is in contact with a rack of the first part; and
while the pinions are configured to turn at same rate but due to their different sizes the rack of the third part moves more than the rack of the second part, and extension amount of the third part correlates to distance between axels of the smaller pinion and the larger one that is in contact with the rack of the third part.

11. The telescopic arm assembly of claim 10, wherein the pinions in the pinion complex are in direct contact with each other.

12. The telescopic arm assembly of claim 10, wherein the pinions in the pinion assembly are not in contact with each other, but each has its own pulley and the pinions are connected with a toothed drive belt.
